(19) United States
(12) Patent Application Publication
(10) Pub. No.: US 2019/0069349 A1
(43) Pub. Date: Feb. 28, 2019

(54) ELECTRICAL HEATER

(71) Applicant: BETACERA INC., New Taipei City (TW)

(72) Inventors: Etsuro Habata, New Taipei City (TW); Chih-Chang WEI, New Taipei City (TW)

(21) Appl. No.: 15/861,681

(22) Filed: Jan. 4, 2018

(30) Foreign Application Priority Data
Aug. 31, 2017 (TW) 106212962

(51) Int. Cl. H05B 3/04; H05B 3/12; H05B 3/82

(52) U.S. Cl. CPC H05B 3/04; H01C 7/02; H05B 3/82; H05B 3/12

(57) ABSTRACT

An electrical heater includes two thermally conductive insulating plates, a PTC heating module, a housing, and two waterproof end caps. The PTC heating module is interposed between the two thermally conductive insulating plates. The housing receives the heating module and the two thermally conductive insulating plates, and includes two open ends. The two waterproof end caps include a first waterproof end cap and a second waterproof end cap disposed corresponding to the two open ends respectively. A waterproof effect is ensured by avoiding the use of waterproof adhesives which have poor adhesion when contacted by water.

### TECHNICAL FIELD

The present invention relates to a heating device and, in particular, to an electrical heater using a positive-temperature-coefficient (PTC) heating module.

### BACKGROUND

The PTC heating module is a heating module which has a positive-temperature-coefficient (PTC) heating unit.

Many electrical heaters are used in a wet environment like a dryer or a combined washer and dryer. In this case, the electrical heater needs to contact water or to be immersed in water, so it is important for the electrical heater to be waterproofed.

The conventional electrical heater includes a hollow tube, a PTC heating module received in the hollow tube, and two heat diffusion elements in the hollow tube. In order to waterproof the PTC heating module in the hollow tube, a waterproof adhesive is filled into two ends of the hollow tube.

However, after the electrical heater contacts water or is immersed in water for a period of time, the waterproof adhesive directly exposed to the outside does not stick well and generate crevices through which water may enter, which damages the waterproof effect and causes the PTC heating module to be short-circuited by water entering.

In view of this, the inventor studied various technologies and created an effective solution in the present disclosure.

### SUMMARY

It is an object of the present invention to provide an electrical heater. Waterproof end caps are used to seal two open ends of a housing for waterproofing. The waterproof effect is ensured by avoiding the use of waterproof adhesives which have poor adhesion when contacted by water.

Accordingly, the present invention provides an electrical heater, comprising: two thermally conductive insulating plates; a positive-temperature-coefficient (PTC) heating module interposed between the two thermally conductive insulating plates; a housing, the housing receiving the PTC heating module and the two thermally conductive insulating plates and including two open ends; and two waterproof end caps including a first waterproof end cap and a second waterproof end cap disposed corresponding to the two open ends to cover the same.

Compared to conventional techniques, the waterproof end caps are used to seal the two open ends of the housing for waterproofing. The waterproof effect is ensured by avoiding the use of waterproof adhesives which have poor adhesion when contacted by water.

### BRIEF DESCRIPTION OF THE DRAWINGS

The disclosure will become more fully understood from the detailed description and the drawings given herein below for illustration only, and thus does not limit the disclosure, wherein:

FIG. 1 is a perspective exploded view illustrating an electrical heater according to the first embodiment of the present invention;

FIG. 2 is a perspective partial exploded view illustrating the electrical heater according to the first embodiment of the present invention;

FIG. 3 is a perspective exploded view illustrating the electrical heater being partially assembled according to the first embodiment of the present invention;

FIG. 4 is a perspective assembled view illustrating the electrical heater according to the first embodiment of the present invention;

FIG. 5 is a cross-sectional view illustrating the electrical heater according to the first embodiment of the present invention;

FIG. 6 is another cross-sectional view illustrating the electrical heater according to the first embodiment of the present invention; and

FIG. 7 is a partial cross-sectional view illustrating the electrical heater according to the second embodiment of the present invention.

### DETAILED DESCRIPTION

Detailed descriptions and technical contents of the present invention are illustrated below in conjunction with the accompany drawings. However, it is to be understood that the descriptions and the accompanying drawings disclosed herein are merely illustrative and exemplary and not intended to limit the scope of the present invention.

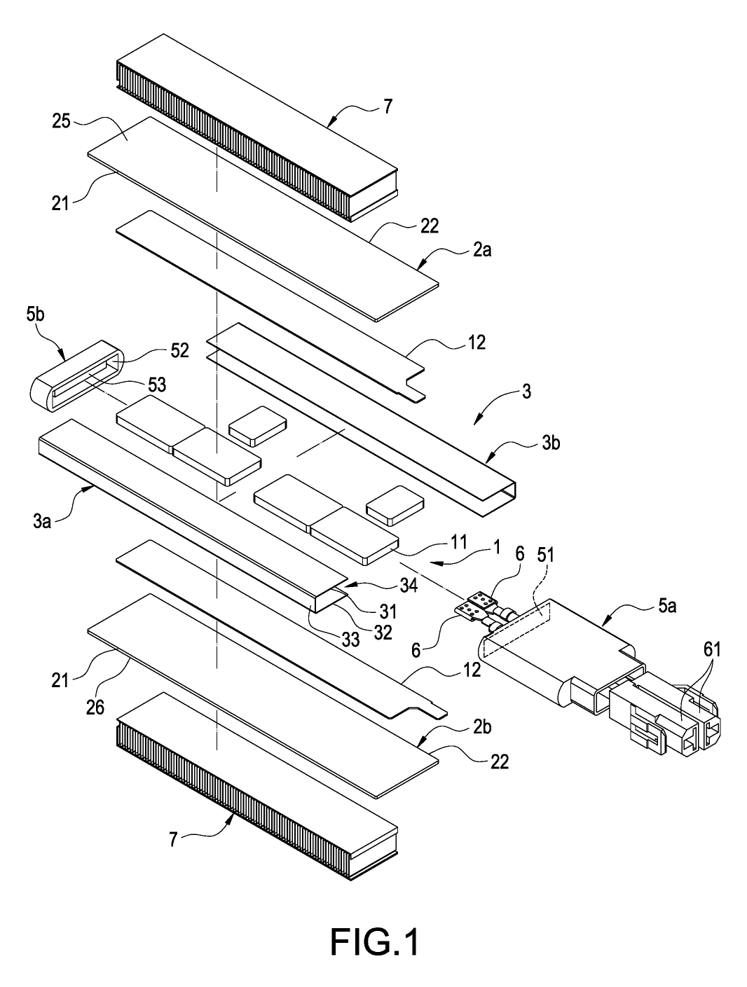

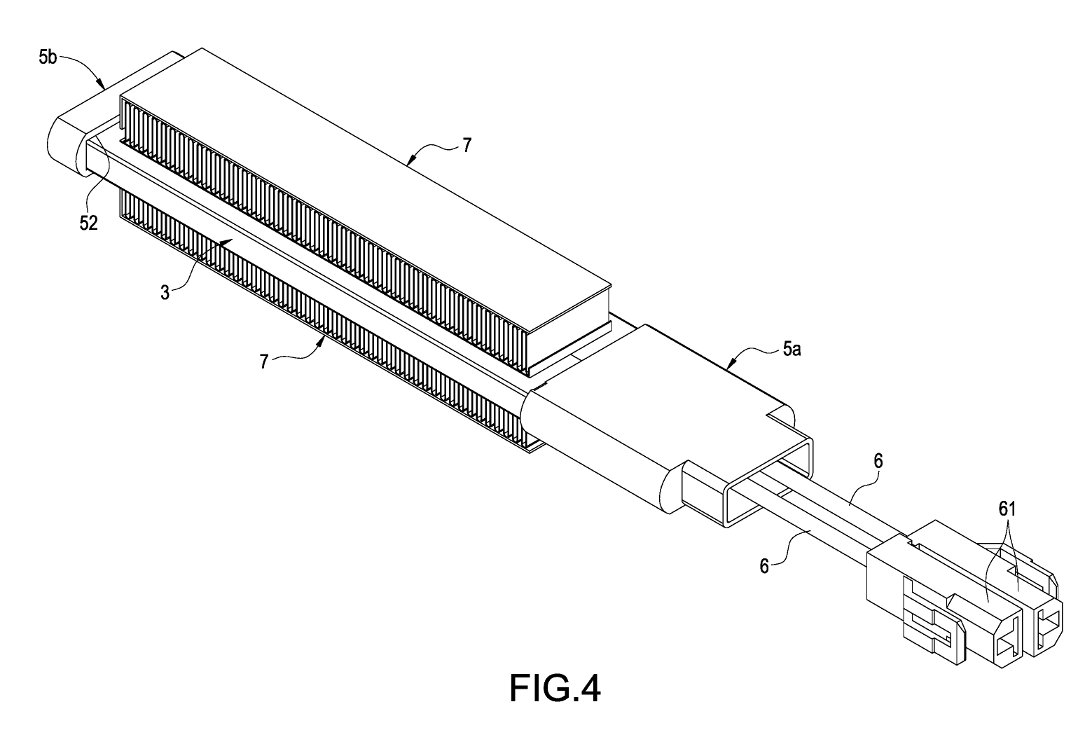

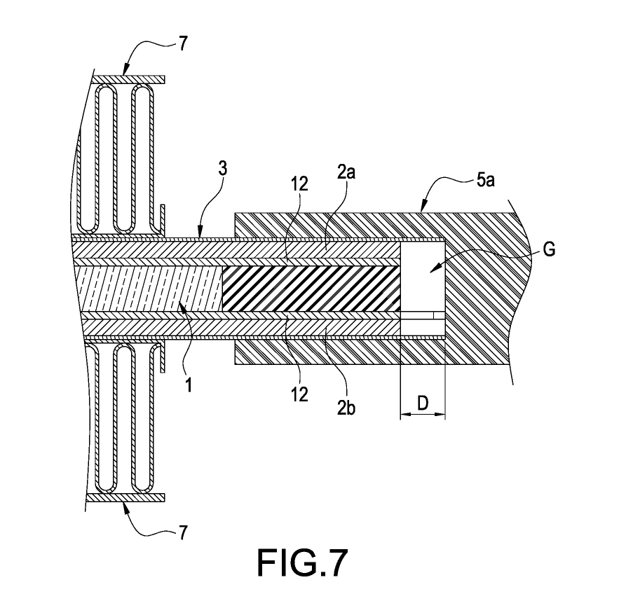

The present invention provides an electrical heater. FIGS. 1 to 6 illustrate the electrical heater according to the first embodiment of the present invention. FIG. 7 illustrates the electrical heater according to the second embodiment of the present invention.

Referring to FIGS. 1 to 5, the electrical heater according to the first embodiment includes a positive-temperature-coefficient (PTC) heating module 1, two thermally conductive insulating plates, a housing 3, and two waterproof end caps. The electrical heater also includes two electrical connection members 6 and two heat diffusion modules 7.

The two thermally conductive insulating plates include a first thermally conductive insulating plate 2a and a second thermally conductive insulating plate 2b. The first thermally conductive insulating plate 2a and the second thermally conductive insulating plate 2b consist of aluminum oxide, aluminum nitride, silicon nitride, silicon carbide, or other suitable material.

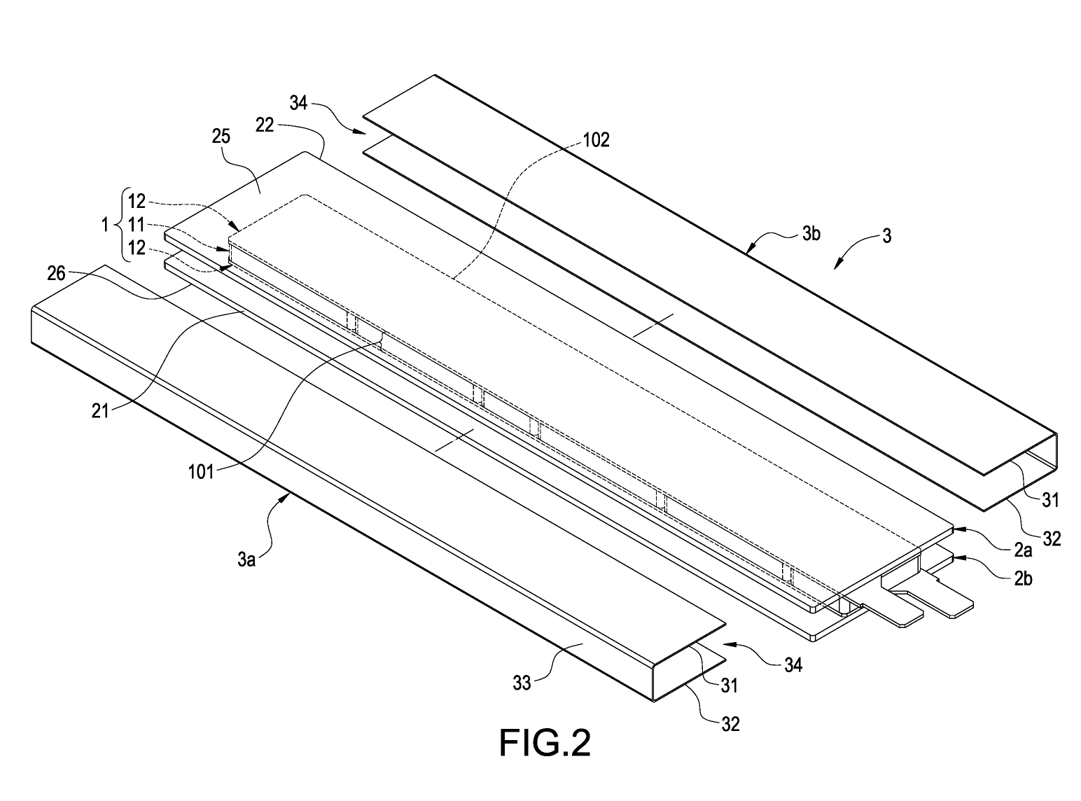

The PTC heating module 1 is interposed between the first thermally conductive insulating plate 2a and the second thermally conductive insulating plate 2b (see FIG. 2). The PTC heating module 1 includes two electrode plates 12 and at least one PTC heating unit 11 interposed between the two electrode plates 12. The present invention is not limited to any particular number of the PTC heating units 11. As one example, in the present embodiment, multiple PTC heating modules are used. The PTC heating units 11 are arranged in a straight line (see FIGS. 1 and 2).

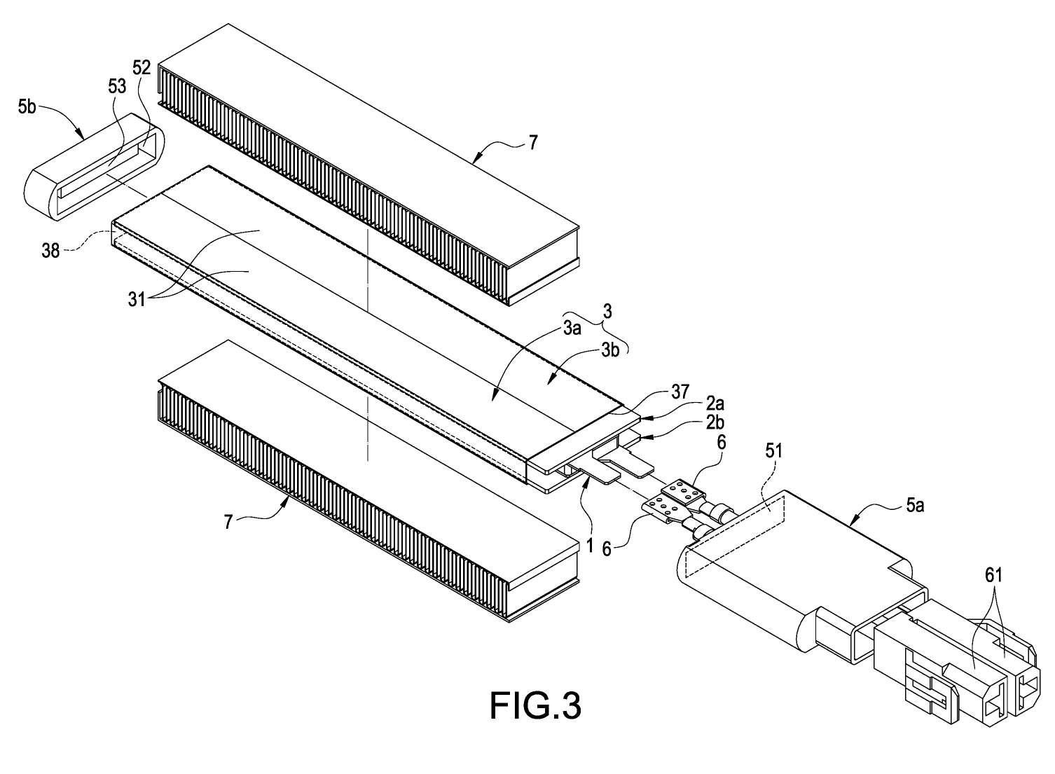

The housing 3 can be a one-piece hollow tube (not illustrated) receiving the first thermally conductive insulating plate 2a, the second thermally conductive insulating plate 2b, and the PTC heating module 1 which has the PTC heating unit 11 sandwiched inside. The housing 3 has two open ends, i.e. a first open end 37 and a second open end 38 (see FIG. 3). The PTC heating module 1 is only exposed from the first open end 37 and the second open end 38. The housing 3 is made of aluminum or aluminum alloy.

Two waterproof end caps include a first waterproof end cap 5a and a second waterproof end cap 5b. The first waterproof end cap 5a is disposed corresponding to the first open end 37 to cover the housing 3, and the second waterproof end cap 5b is disposed corresponding to the second open end 38 to cover the housing 3, so that the first and second waterproof end caps 5a, 5b seal the first and second open ends 37, 38, respectively. By this configuration, the PTC heating module 1 is sealed between the housing 3, the first waterproof end cap 5a and the second waterproof end cap 5b to be waterproofed. The first waterproof end cap 5a and the second waterproof end cap 5b both consist of soft gel-like material like rubber or silicone.

The two electrical connection members 6 are electrically connected to the two electrode plates 12 through the first open end 37. The two electrical connection members 6 are inserted and connected to the first waterproof end cap 5a. It is preferable that the two electrical connection members 6 each have an electrical connector 61 at one end, so that the electrical connection members 6 can be pulled out or plugged in easily.

The two heat diffusion modules 7 can be attached anywhere on the housing 3. As an example shown in the drawing, the two heat diffusion modules 7 are attached to opposite two sides (e.g. a top side and a bottom side) of the housing 3. Referring to FIG. 3, the heat diffusion module 7 includes two fixing boards (not labelled) and a fin set (not labelled) disposed between the two fixing boards.

The housing 3 can be the above-mentioned one-piece hollow tube (not illustrated), or can be a two-part structure shown in FIG. 6 and FIGS. 1 to 3, as detailed hereinafter.

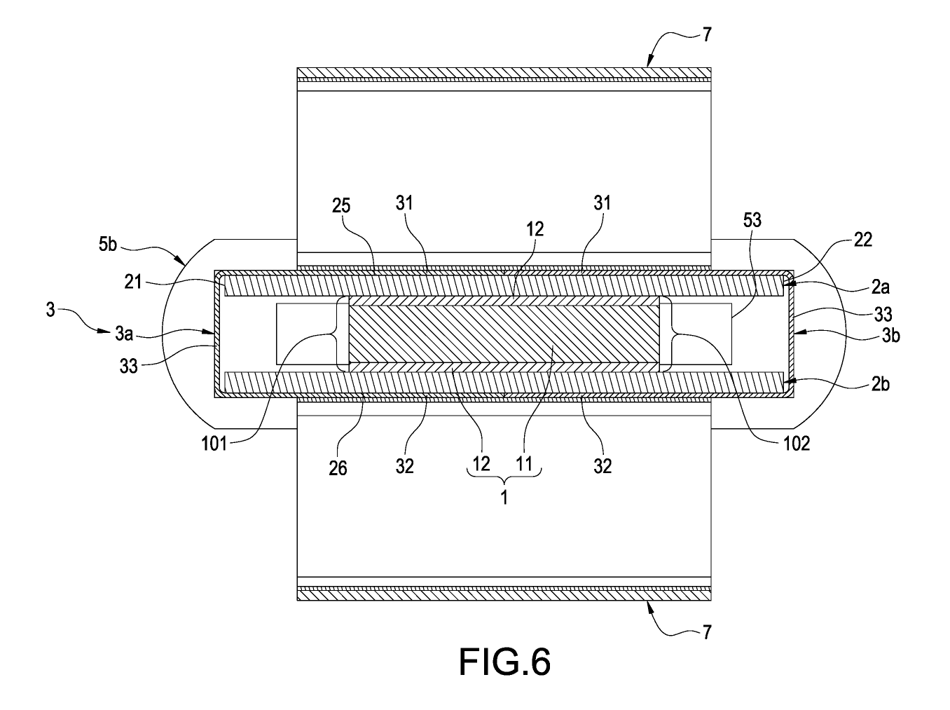

The two-part structure of the housing 3 includes a first lateral damper 3a and a second lateral clamper 3b. It is preferable that the first lateral clamper 3a and the second lateral damper 3b are arranged corresponding to each other. Each of the first lateral clamper 3a and the second lateral damper 3b includes an upper clamping board 31, a lower clamping board 32 and a connection portion 33. The connection portion 33 is connected between one edge of the upper clamping board 31 and one edge of the lower clamping board 32, so that the upper clamping board 31, the lower clamping board 32 and the connection portion 33 form a clamping opening 34. In other words, the first lateral damper 3a in cross section is of a U shape. The second lateral damper 3b corresponds in shape to the first lateral damper 3a. The PTC heating module 1 includes two lateral sides, i.e. a first lateral side 101 and a second lateral side 102 opposite to each other (see FIG. 6). Each of the first and second thermally conductive insulating plates 2a, 2b also includes two lateral sides, i.e. a first lateral side 21 and a second lateral side 22 (see FIGS. 1, 2 and 6) opposite to each other.

The first lateral damper 3a is arranged toward the two first lateral sides 101, 21 to clamp and fasten left portions of the PTC heating module 1 and the first and second thermally conductive insulating plates 2a, 2b. The second lateral clamper 3b is arranged toward the two second lateral sides 102, 22 to clamp and fasten right portions of the PTC heating module 1 and the first and second thermally conductive insulating plates 2a, 2b. Therefore, the upper clamping board 31 of the first lateral clamper 3a and the upper clamping board 31 of the second lateral damper 3b are arranged side by side to together clamp the upper clamping surface 25 of the first thermally conductive insulating plate 2a, and the lower clamping board 32 of the first lateral damper 3a and the lower clamping board 32 of the second lateral damper 3b are arranged side by side to together clamp the lower clamping surface 26 of the second thermally conductive insulating plate 2b. Accordingly, a left portion and a right portion of a received object (i.e. the object received inside the housing 3; the object is formed by the PTC heating module 1 and the first and second thermally conductive insulating plates 2a, 2b) are tightly clamped in the clamping openings 34 of the first lateral clamper 3a and the second lateral damper 3b, and thereby the PTC heating module 1, the first thermally conductive insulating plate 2a and the second thermally conductive insulating plate 2b stacked one above the other are clamped tightly to facilitate more efficient heat conduction. At this point, the upper clamping board 31 and the lower clamping board 32 of each of the first and second lateral dampers 3a, 3b overlap and closely contact the upper clamping surface 25 and the lower clamping surface 26 of the two thermally conductive insulating plates 2a, 2b to also facilitate good heat conduction.

Furthermore, the first and second waterproof end caps 5a, 5b include recesses 51, 52 respectively, and the recess 51 receives and positions the open end 37 of the housing 3, the recess 52 receives and positions the second open end 38 of the housing 3, so that the first and second waterproof end caps 5a, 5b also provide a positioning effect to thereby retain the first lateral damper 3a and the second lateral damper 3b in side-by-side relationship, thus preventing the first lateral damper 3a and the second lateral damper 3b from being detached or offset from each other.

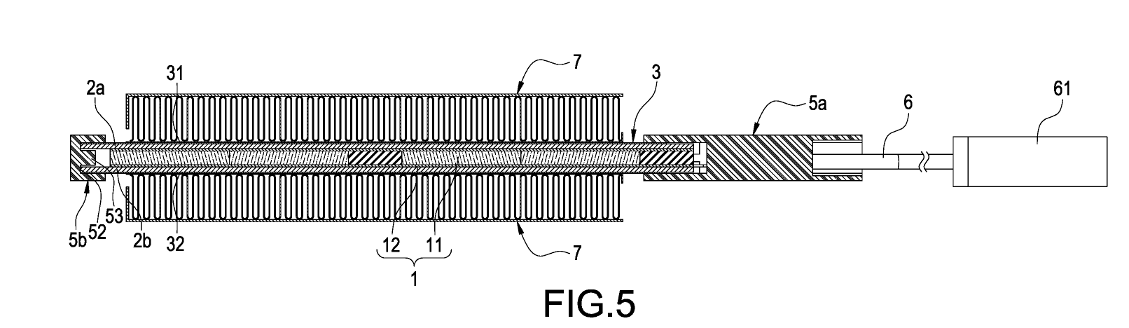

The second waterproof end cap 5b can include a protruding portion 53 (see FIGS. 1, 3 and 5) corresponding to the recess 52, the protruding portion 53 is inserted between one ends (i.e. the left end in FIG. 5) of the two thermally conductive insulating plates 2a, 2b, and the one ends of the two thermally conductive insulating plates 2a, 2b and the second open end 38 of the housing 3 are inserted between the second waterproof end cap 5b and the protruding portion 53. In this way, the second waterproof end cap 5b can be stably fixed to the housing 3.

Please refer to FIG. 7 illustrating the electrical heater according to the second embodiment. The second embodiment is similar to the first embodiment, and the difference between them is that the second embodiment further has two air gaps G, as detailed hereinafter.

The housing 3 is lengthened in order to form one air gap G between the first waterproof end cap 5a, the first open end 37, and one end of the PTC heating module 1 and to form the other air gap G between the second waterproof end cap 5b, the second open end 38 and the other end of the PTC heating module 1. The first open end 37 protrudes by a protruding length D (see FIG. 7) with respect to one end of the first thermally conductive insulating plate 2a and one end of the second thermally conductive insulating plate 2b, and the second open end 38 protrudes by a protruding length D (not illustrated in FIG. 7) with respect to the other end of the first thermally conductive insulating plate 2a and the second thermally conductive insulating plate 2b, so as to form the two air gaps G for containing more air. The protruding length D can be within the range of 0.1 mm to 0.3 mm.

The air gap G provides more air to cause the PTC heating unit 11 to have improved performance and an extended lifespan.

In summary, compared to conventional techniques, the present invention has the following effects. The first waterproof end cap 5a and the second waterproof end cap 5b seal the first open end 37 and the second open end 38 of the housing 3 for waterproofing. The present invention can ensure the waterproof effect by avoiding the use of waterproof adhesives which have poor adhesion when contacted by water.

The present invention also has other effects. The housing 3 is a two-part structure consisting of the first lateral damper 3a and the second lateral damper 3b, so that the PTC heating module 1, the first thermally conductive insulating plate 2a, the second thermally conductive insulating plate 2b are tightly clamped and thereby maintained in a stacked configuration. In addition to that, the upper clamping board 31 and the lower clamping board 32 of each of the first and second lateral dampers 3a, 3b overlap and closely contact the upper clamping surface 25 and the lower clamping surface 26 of the two thermally conductive insulating plates 2a, 2b, thus enhancing heat conduction efficiency. By adding the air gap G, there is more air to promote the performance of the PTC heating unit 11 and extend a lifespan thereof.

As to the housing 3 formed by a one-piece structure having a hollow tube shape, which is not illustrated in the drawings, the above-mentioned received object needs to be smaller than the one-piece-structure housing 3 in order to be fit inside it, so the one-piece-structure housing 3 cannot fix the received object in compact and snuggle relationship. As a result, the housing 3 formed a two-part structure has better heat conduction efficiency than the housing 3 formed by a one-piece structure having a hollow tube shape.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. An electrical heater, comprising:
two thermally conductive insulating plates;
a positive-temperature-coefficient (PTC) heating module interposed between the two thermally conductive insulating plates;
a housing, the housing receiving the PTC heating module and the two thermally conductive insulating plates and including two open ends; and
two waterproof end caps including a first waterproof end cap and a second waterproof end cap disposed corresponding to the two open ends to cover the same.

2. The electrical heater according to claim 1, wherein each of the two waterproof end caps is a rubber sealing cap or a silicone sealing cap.

3. The electrical heater according to claim 1, further including two electrical connection members, the PTC heating module including two electrode plates and at least one PTC heating unit interposed between the two electrode plates, the two-electrical connection member being electrically connected to the two electrode plates through one of the two open ends, the two electrical connection members being inserted and connected to the first waterproof end cap.

4. The electrical heater according to claim 1, further comprising two heat diffusion modules, the two heat diffusion modules being in contact with the housing.

5. The electrical heater according to claim 1, wherein the housing includes a first lateral damper and a second lateral clamper, the PTC heating module includes two lateral sides, the two thermally conductive insulating plates each include two lateral sides, and the PTC heating module and the two thermally conductive insulating plates are clamped by the first lateral damper arranged corresponding to the respective corresponding two lateral sides and the second lateral damper arranged corresponding to the respective corresponding two lateral sides.

6. The electrical heater according to claim 5, wherein each of the first lateral damper and the second lateral damper includes an upper clamping board, a lower clamping board, and a connection portion connected between the upper clamping board and the lower clamping board, the two thermally conductive insulating plates each include an upper clamping surface and a lower clamping surface, the respective upper clamping boards of the first lateral damper and the second lateral damper clamp the upper clamping surface, and the respective lower clamping boards of the first lateral damper and the second lateral damper clamp the lower clamping surface.

7. The electrical heater according to claim 5, wherein the first lateral damper in cross section is of a U shape, and the second lateral damper corresponds in shape to the first lateral damper.

8. The electrical heater according to claim 1, wherein the waterproof end caps include two recesses respectively, and the two recesses receive and position the two open ends of the housing, respectively.

9. The electrical heater according to claim 8, wherein the second waterproof end cap includes a protruding portion corresponding to the recess, the protruding portion is inserted between one ends of the two thermally conductive insulating plates, and the one ends of the two thermally conductive insulating plates and the corresponding open end are inserted between the second waterproof end cap and the protruding portion.

10. The electrical heater according to claim 5, wherein the waterproof end caps include two recesses respectively, and the two recesses receive and position the two open ends of the housing, respectively.

11. The electrical heater according to claim 10, wherein the second waterproof end cap includes a protruding portion corresponding to the recess, the protruding portion is inserted between one ends of the two thermally conductive insulating plates, and the one ends of the two thermally conductive insulating plates and the corresponding open end are inserted between the second waterproof end cap and the protruding portion.

12. The electrical heater according to claim 1, further comprising two air gaps, each air gap being formed between the respective waterproof end cap, the respective open end, and the respective one end of the PTC heating module.

13. The electrical heater according to claim 12, wherein the two open ends protrude beyond two ends of each of the thermally conductive insulating plates, respectively.
